(19) United States
(12) Patent Application Publication
(10) Pub. No.: US 2025/0259098 A1
(43) Pub. Date: Aug. 14, 2025

(54) SYSTEMS AND METHODS FOR AUTOMATED CLUSTERING OF MULTI-DIMENSIONAL AI/ML TRAINING DATA

(71) Applicant: Verizon Patent and Licensing Inc., Basking Ridge, NJ (US)

(72) Inventor: Corey J. Christopherson, Bainbridge Island, WA (US)

(73) Assignee: Verizon Patent and Licensing Inc., Basking Ridge, NJ (US)

(21) Appl. No.: 18/440,530

(22) Filed: Feb. 13, 2024

(51) Int. Cl. G06N 20/00

(52) U.S. Cl. CPC G06N 20/00

(57) ABSTRACT

A system described herein may receive a plurality of data sets; generate, for each data set, an Eigenvector representing a maximum variance of the data set; generate, for each data set, a projected vector, wherein generating a particular projected vector includes identifying a lowest distance between respective values of the particular data set and the particular Eigenvector, wherein the particular projected vector includes values along the Eigenvector that are each a lowest distance from a corresponding value of the particular data set; compare respective projected vectors, associated with one or more data sets, with one or more other data sets of the plurality of data sets; generate a plurality of clusters based on the comparing, wherein each cluster includes one or more data sets of the plurality of data sets; and train one or more artificial intelligence/machine learning (“AI/ML”) models based on the plurality of clusters.

### BACKGROUND

Artificial intelligence/machine learning (“AI/ML”) techniques may be used to categorize or classify data sets, such as wireless network Key Performance Indicators (“KPIs”), time series data, features of images or other types of content, autonomous vehicle control data, etc. AI/ML techniques may make use of models to generate output parameters such as categories, classifications, actions, etc. based on input parameters such as wireless network KPIs, images, autonomous vehicle sensor data, etc. The AI/ML models may, for example, be trained or configured based on training data. For example, training data may be provided as input to a model, and the model may be “trained” to generate a particular set of output parameters (e.g., a known or desired set of output parameters) based on the training data. Once trained (e.g., at “run time”), the model may provide the same (or similar) output parameters when receiving the same (or similar) input parameters at run time.

### BRIEF DESCRIPTION OF THE DRAWINGS

FIG. 1 illustrates an example overview of one or more embodiments described herein;

FIGS. 2-5 illustrate examples of pre-processing one or more multi-dimensional data sets, in accordance with some embodiments;

FIG. 6 illustrates an example of generating a multi-dimensional Eigenvector to represent a maximum variation in values of a multi-dimensional data set, in accordance with some embodiments;

FIG. 7 illustrates an example of generating a multi-dimensional projected vector based on a multi-dimensional Eigenvector associated with a data set, in accordance with some embodiments;

FIG. 8 illustrates values of an example multi-dimensional projected vector, in accordance with some embodiments;

FIG. 9 illustrates an example of clustering multi-dimensional data sets based on multi-dimensional projected vector associated with each of the multi-dimensional data sets, in accordance with some embodiments;

FIG. 10 illustrates an example of generating or refining an AI/ML model based on the clustered multi-dimensional data sets, in accordance with some embodiments;

FIG. 11 illustrates an example environment in which one or more embodiments, described herein, may be implemented; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for an automated clustering and/or classification procedure to facilitate a training stage of one or more AI/ML models. The automated clustering and/or classification procedure described herein may remove the need for manual review of training data sets to group similar data sets (e.g., supervised machine learning training techniques), thus enhancing the overall efficiency and speed of the training process for AI/ML modeling systems.

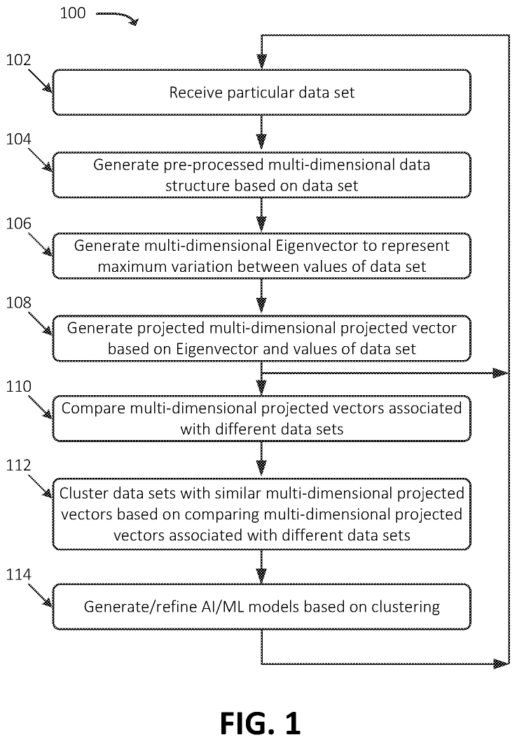

FIG. 1 illustrates an example process 100 for training one or more AI/ML models using an automated clustering technique as described herein. In some embodiments, some or all of process 100 may be performed by one or more computing devices that generate or refine AI/ML models and/or training data used in the training of AI/ML models. Process 100 is described in conjunction with subsequent figures, which illustrate some or all of the operations of process 100.

As shown, process 100 may include receiving (at 102) a particular data set. The particular data set may include values associated with wireless network KPIs (e.g., interference, noise, latency, throughput, etc.), sensor readings (e.g., readings measured or reported by Internet of Things (“IoT”) devices, automated guided vehicles (“AGVs”), autonomous factory robots, etc.), content files (e.g., images, videos, audio, etc.), and/or other suitable data. In some embodiments, the data set may include time series data, where values for particular parameters or variables may differ over time.

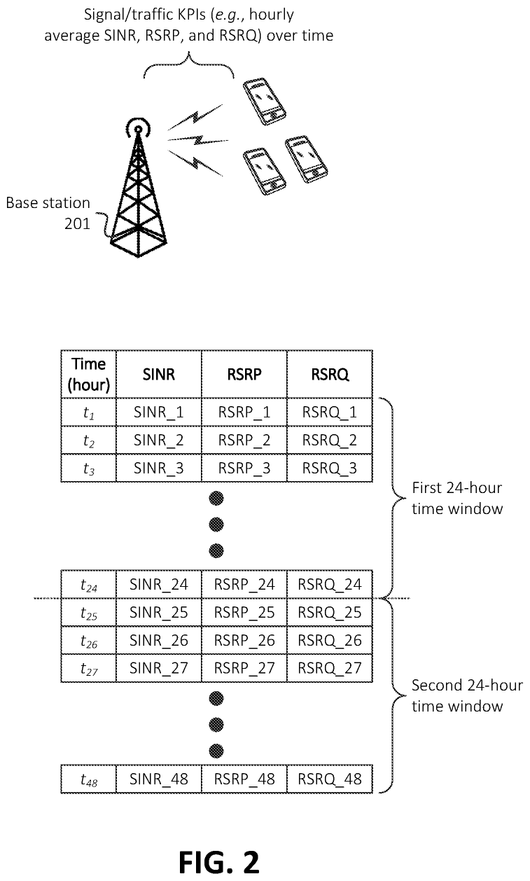

FIG. 2 illustrates an example of one or more data sets that may be the subject of operations described herein with respect to the automatic clustering and/or classification of such data. In this example, time series data may reflect signal and/or traffic KPIs associated with a radio access network (“RAN”) of a wireless network, such as signal and/or traffic KPIs associated with a particular base station 201 of the RAN. In the examples discussed herein, multiple different KPIs may be reflected in the data, such as Signal-to-Interference-and-Noise-Ratio (“SINR”), Reference Signal Received Power (“RSRP”), and Reference Signal Received Quality (“RSRQ”). In these examples, each value for each KPI may be associated with a particular time or time period. For example, a first SINR value (represented as “SINR_1”) may be associated with a first time period t₁, a second SINR value (e.g., SINR_2) may be associated with a second time period t₂, and so on. Similarly, a first RSRP value (e.g., RSRP_1) may be associated with the first time period t₁, a second RSRP value (e.g., RSRP_2) may be associated with the second time period t₂, and so on.

In the examples described herein, the time periods are delineated on an hourly basis. For example, t₁ may refer to a first hour, t₂ may refer to a second hour (e.g., an hour that is immediately subsequent to the hour represented by t₁), and so on. Each respective value may be “associated with” a particular time period inasmuch as the values may include readings or measurements determined at specific times or offsets for each time period. For example, SINR_1 may reflect one or more SINR measurements (e.g., between base station 201 and one or more User Equipment (“UEs”), such as mobile telephones, that are wirelessly connected to base station 201) that are determined at the beginning of the first hour, SINR_2 may reflect one or more SINR measurements that are determined at the beginning of the second hour, and so on. Additionally, or alternatively, the values may reflect average values. For example, SINR_1 may reflect an average SINR between base station 201 and one or more UEs over the entire first hour, SINR_2 may reflect an average SINR between base station 201 and one or more UEs over the entire second hour, and so on. Additionally, or alternatively, the values may otherwise reflect readings or measurements associated with particular time periods in some other way. For example, SINR_1 may refer to the highest SINR value associated with t₁(e.g., the highest SINR value determined during the hour represented by t₁), the lowest SINR value associated with t₁, the average of SINR values that are between the 25th and 75th percentile of SINR values associated with t₁, and so on.

In some embodiments, discrete data sets may be identified or extracted from received data. The discrete data sets may be identified based on parameters of an AI/ML model to be trained, and/or based on input parameters of training data used to train an AI/ML model. In this example, the training data is specified to include hourly KPIs on separate 24-hour windows. In this sense, the hourly KPIs associated with the first 24 hours (i.e., t₁ through t₂₄) may be identified as a first data set, the hourly KPIs associated with the next 24 hours (i.e., t₂₅ through t₄₈) may be identified as a second data set, and so on. Accordingly, one or more operations described herein (e.g., operations 102-108) may be performed with respect to each data set (e.g., RAN KPIs for each 24-hour window, in this example).

Process 100 may further include generating (at 104) a pre-processed multi-dimensional data structure based on the particular data set. Pre-processing the data set may include normalizing the data to a particular quantity of dimensions, quantity or types of values, etc. In the example above, 24 SINR values are received, 24 RSRP values are received, and 24 RSRQ values are received (e.g., where each value is associated with a particular hourly time period). In such embodiments, each hourly value may be considered as a “dimension” for such value. For example, the 24 SINR values for the dataset may be represented as a first 24-dimensional point on a graph with 24 axes (e.g., dimensions), the 24 RSRQ values may be represented as a second 24-dimensional point on the graph, etc.

In some embodiments, normalizing the data set may include assigning scores, weights, values, etc. in a same value range or space for the different types of values. For example, SINR values may be converted, translated, etc. from a range of values between 0 dB and 40 dB to a normalized range of values of 1 through 100, RSRP values may be converted from a range of values between −100 dbm through −80 dbm to the same normalized range of values of 1 through 100, RSRQ values may be converted from a range of values between −20 dB through −10 dB to the same normalized range of values of 1 through 100, and so on.

In some scenarios, values may not necessarily be keyed to a specific dimensionality. For example, the received data set may include eight SINR values received over a first hour, twelve SINR values received over a second hour, etc. Normalizing the data may include aggregating, combining, etc. such values to a single SINR value for the first hour, a single SINR value for the second hour, etc.

In some embodiments, pre-processing the data set may include transposing the data, in which rows of the data are represented as columns, and in which columns of the data are represented as rows. The transposing may be used to represent each parameter of the data set in multiple dimensions, where each dimension is associated with a particular instance of the parameter. For example, as noted above, as a result of transposing the data, the SINR parameter may be represented as 24 dimensions, where each dimension represents a separate instance of the SINR parameter (e.g., separate hourly measurements of the SINR parameter).

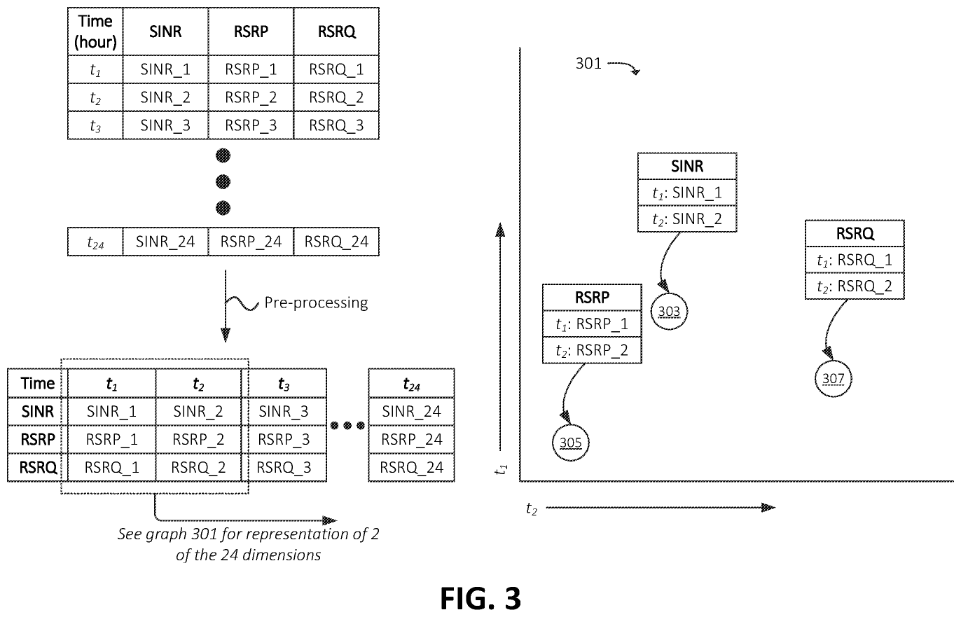

Graph 301 may be a graphical representation of the pre-processed data set (e.g., the transposed and/or normalized data set). Each parameter may be plotted as a multi-dimensional point, and the axes of graph 301 may each represent the different dimensions. In FIG. 3, graph 301 represents two of the 24 example dimensions, similar to how a two-dimensional image may be used to represent a three-dimensional object (e.g., a picture of a pumpkin may be a two-dimensional image, while the pumpkin itself exists in three dimensions). The axes may each be in the same normalized value range, such as 1 through 100, as discussed above (e.g., a value at the bottom of the t₁ axis may be 1 while a value at the top of the t₁ axis may be 100, and a value at the left of the t₂ axis may be 1 while a value at the right of the t₂ axis may be 100).

Point 303 represents two dimensions of the SINR parameter. For example, the position on the t₁ axis represents the normalized SINR value at time t₁, and the position on the t₂ axis represents the normalized SINR value at time t₂. Similarly, point 305 represents two dimensions of the RSRP parameter, and point 307 represents two dimensions of the RSRQ parameter.

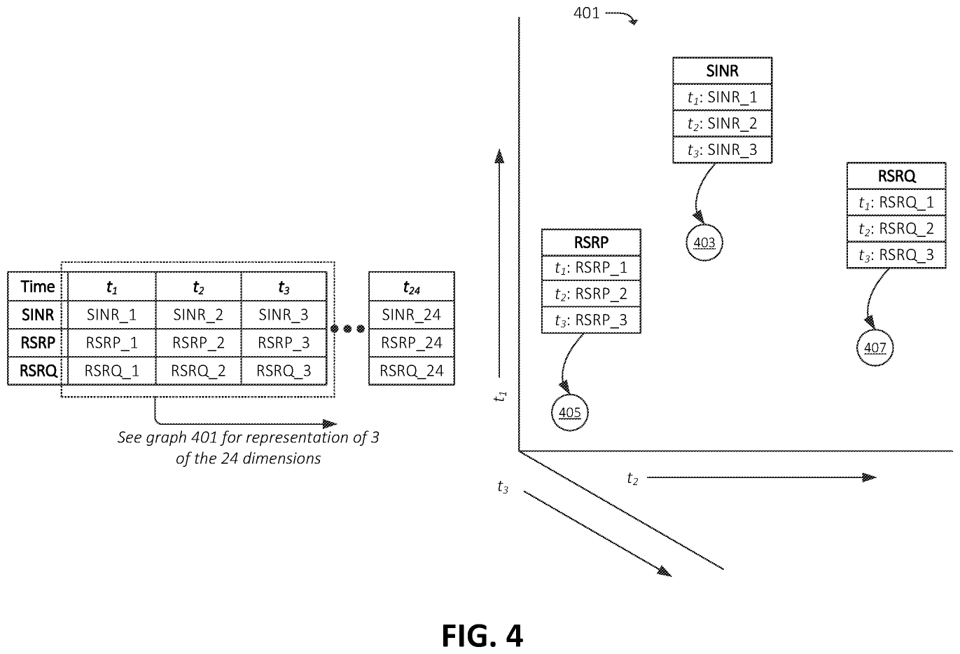

FIG. 4 includes graph 401, in which three of the dimensions of each parameter are represented in graphical form. Point 403 represents three dimensions of the SINR parameter, point 405 represents three dimensions of the RSRP parameter, and point 407 represents three dimensions of the RSRQ parameter. In this vein, multiple (e.g., more than three) dimensions may be represented by multi-dimensional points for each parameter.

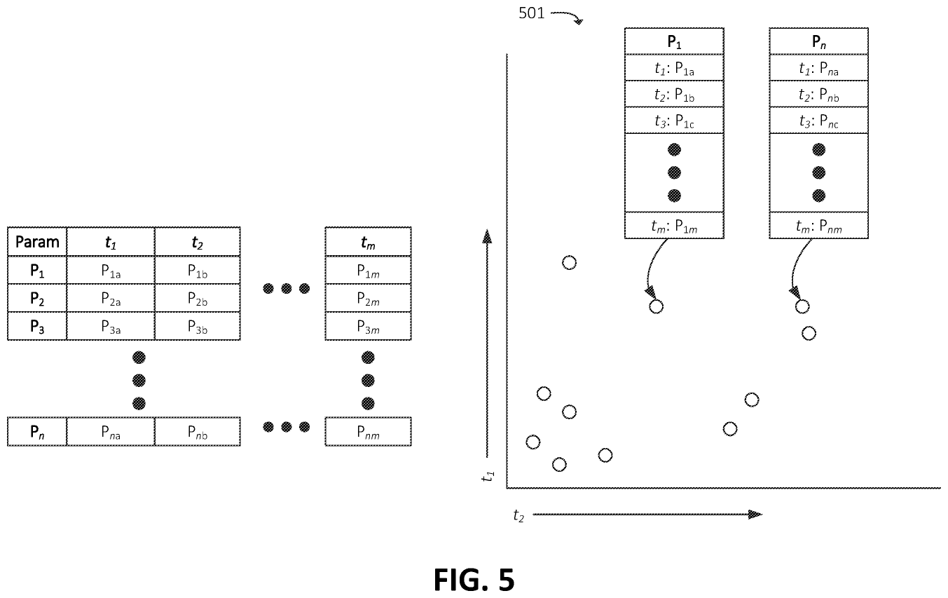

For example, as shown in FIG. 5, n parameters may each be associated with m dimensions. To provide context to the parameters and dimensions shown in FIG. 5, note that SINR is an example of a first parameter (e.g., parameter P₁ may refer to SINR values or normalized values based on SINR values), RSRP is an example of a second parameter (e.g., parameter P₂ may refer to RSRP values), and RSRQ is an example of a third parameter (e.g., parameter P₃ may refer to RSRQ values). Similarly, a first dimension may refer to a first hourly measurement or reading, a second dimension may refer to a second hourly measurement or reading, and an m-th dimension may refer to an m-th hourly measurement or reading. For example, referring to example values shown in FIG. 5, P₁ₐ may be a value for the first parameter P₁ at time t₁, P_{1b} may be a value for the first parameter P₁ at time t₂, P₂ₐ may be a value for a second parameter P₂ at time t₁, P_{2b} may be a value for the second parameter P₂ at time t₂, and Pₙₘ may be a value for the n-th parameter Pₙ at time tₘ.

Graph 501 illustrates a plotting of multi-dimensional points that each represent all values for a particular parameter. For example, point P₁ represents all m values for parameter P₁ (i.e., P₁ₐ through P₁ₘ), point P₂ represents all m values for parameter P₂ (i.e., P₁₂ through P₂ₘ), point Pₙ represents all values for parameter Pₙ (i.e., Pₙₐ through Pₙₘ), and so on. As similarly noted above, a two-dimensional graph 501 is shown to represent the plotting of these points in m dimensions, where m may be an integer that is equal to or greater than 2 (e.g., 3, 24, 50, etc.).

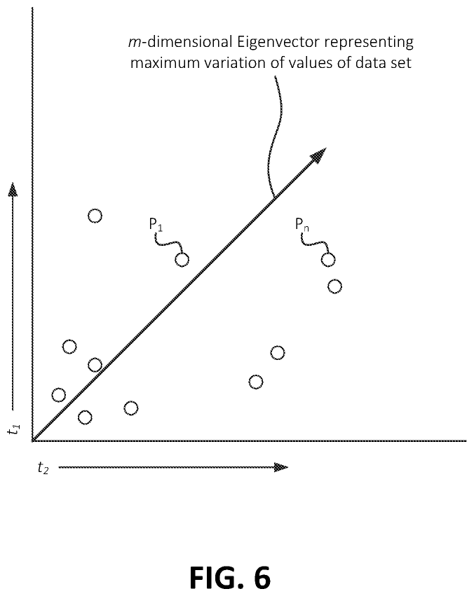

Returning to FIG. 1, process 100 may additionally include generating (at 106) a multi-dimensional Eigenvector to represent the maximum variance, variation, difference, etc. between the values of the particular data set included in the transposed and/or normalized data set. FIG. 6 includes a two-dimensional representation of the m-dimensional Eigenvector that represents the maximum variance of the values of the data set. Since the Eigenvector is an m-dimensional vector, any given point along the Eigenvector would also be an m-dimensional point. In some embodiments, the generated Eigenvector may be defined in terms of an m-dimensional endpoint and/or one or more angles or directions (e.g., originating from a value of 0 or other suitable originating value in each of the m dimensions). The length of the Eigenvector may, in some implements, be a static or pre-set length, and the Eigenvector itself may be defined, denoted, etc. in terms of the m-dimensional endpoint of the Eigenvector and/or the one or more angles or directions from the origin(s) of each dimension, as noted above.

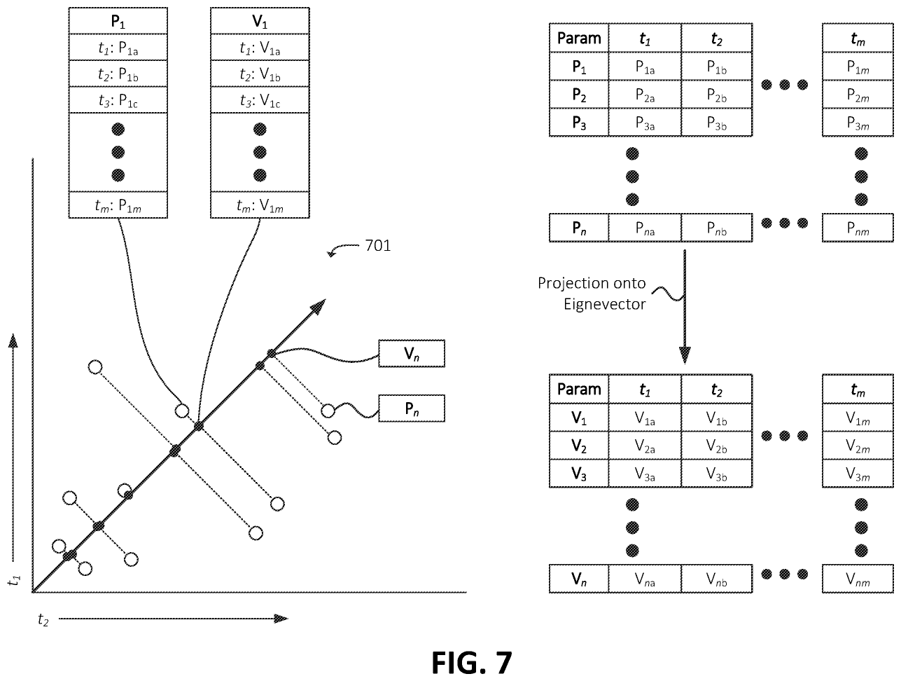

Process 100 may also include generating (at 108) a projected multi-dimensional vector based on the Eigenvector and the values of the data set. For example, as shown in FIG. 7, graph 701 represents the m-dimensional points P₁ through Pₙ, the Eigenvector shown in FIG. 6, as well as points V₁ through Vₙ that represent a projection of each value of the data set (e.g., each “P” point such as points P₁ through Pₙ) onto the Eigenvector. For example, point P₁ may be projected onto the Eigenvector by determining which point (i.e., which m-dimensional point) on the Eigenvector is closest, in m dimensions, to point P₁ (e.g., the lowest distance in m dimensions). In FIG. 7, the closest point on the Eigenvector to point P₁ is represented as point V₁ (e.g., v₁ is the m-dimensional point on the Eigenvector that is the lowest distance, in m dimensions, from point P₁). Similarly, point Pₙ may be projected onto the Eigenvector by determining which point on the Eigenvector is closest to point Pₙ. In FIG. 7, the closest point on the Eigenvector to point P₁ is represented as point V₁, and the closest point on the Eigenvector to point Pₙis represented as point V_{n.}

As noted above, each point projected onto the Eigenvector may be an m-dimensional point. For example, as point P₁ includes m values P₁ₐ through P₁ₘ, the corresponding point v₁ on the Eigenvector also includes m values V₁ₐ through V₁ₘ. That is, the dimensionality of the projected “V” points on the Eigenvector may be the same as the dimensionality of the corresponding “P” points that represent the data set. In this manner, the vector formed by the “V” points (e.g., referred to as the “projected vector” herein) may represent the entire data set (e.g., the normalized data set). Since the projected vector is further based on the Eigenvector that represents the maximum variation of the data included in the data set, the projected vector may be thought of as a “signature” of the original data set.

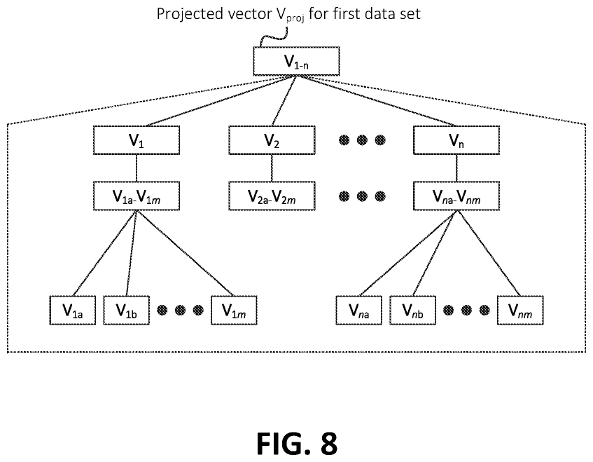

FIG. 8 illustrates a representation of a particular multi-dimensional projected vector Vₚᵣₒⱼ, which may be generated using techniques described above with respect to the particular data set. As noted above, projected vector Vₚᵣₒⱼ may include n points of m dimensions each (e.g., points V₁ through Vₙ). For example, as shown in FIG. 8 and as discussed above, point v₁ may include values V₁ₐ through V₁ₘ, and point Vₙ may include values Vₙₐ through Vₙₘ.

Returning to FIG. 1, some or all of the above-described operations (e.g., operations 102 through 108) may be performed on multiple data sets. For example, a first data set may refer to RAN KPIs measured over a first 24-hour window, a second data set may refer to RAN KPIs measured over a second 24-hour window, and so on. As another example, a first data set may refer to a first image (e.g., may be generated based on a file or set of files with encoded data that represents a first image), a second data set may refer to a second image, and so on. As yet another example, a first data set may refer to first video or audio data (e.g., a file or set of files with encoded data that represents video or audio content), and a second data set may refer to second video or audio data. In some embodiments, the data sets may be or may include other types of data, with applicability to a wide range of technical applications (e.g., image-based autonomous vehicle control, wireless network interference and/or Quality of Service (“QoS”) modeling, audio processing, image recognition, etc.). Generating (e.g., (at 108) multi-dimensional projected vectors for each data set, in accordance with some embodiments, may generate a representation that significantly captures a “signature” or otherwise captures features of each distinct data set.

In some embodiments, the dimensionality of each pre-processed data set may be the same. In this manner, each respective multi-dimensional projected vector Vₚᵣₒⱼ may be compared (at 110), in order to cluster (at 112) data sets with similar multi-dimensional projected vectors. For example, one or more clustering techniques, such as K-means clustering, density-based clustering, hierarchical clustering, and/or other suitable clustering techniques may be used to identify multi-dimensional projected vectors that exhibit at least a threshold measure of similarity. Process 100 may also include generating and/or refining (at 114) one or more AI/ML models based on the clustering.

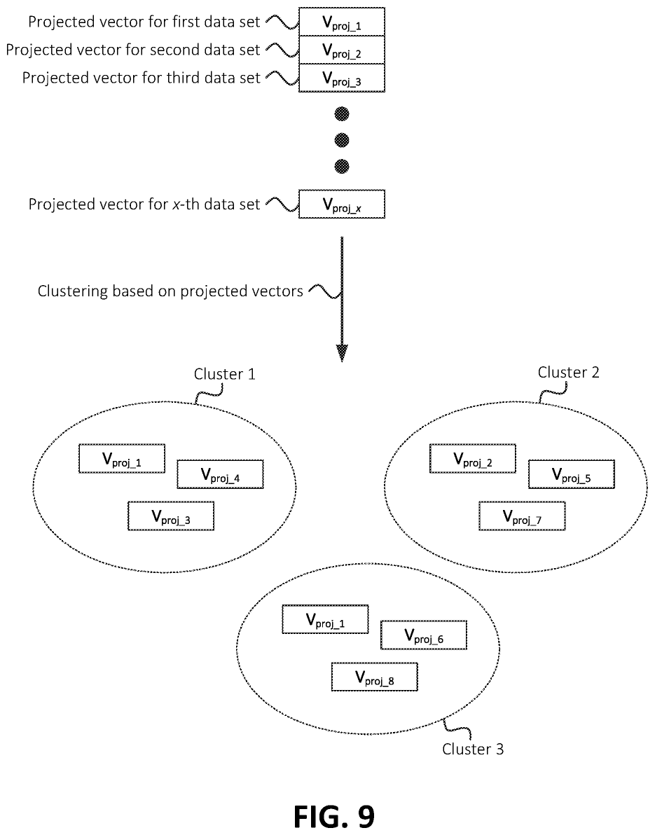

For example, as shown in FIG. 9, multi-dimensional projected vectors V_{proj_1} through V_{proj_x} may have been generated (e.g., based on multiple iterations of operations 102-108) for x different data sets. As discussed above, multi-dimensional projected vectors V_{proj_1} through V_{proj_x} may be made up of m-dimensional points that represent respective original data sets, and may therefore be able to be compared and clustered on the basis of the m-dimensional points. For example, in this example, a first cluster may include respective data sets associated with multi-dimensional projected vectors V_{proj_1}, V_{proj_3}, and V_{proj_4}; a second cluster may include respective data sets associated with multi-dimensional projected vectors V_{proj_2,}V_{proj_5}, and V_{proj_7}; and a third cluster may include respective data sets associated with multi-dimensional projected vectors V_{proj_1}, V_{proj_6}, and V_{proj_8}.

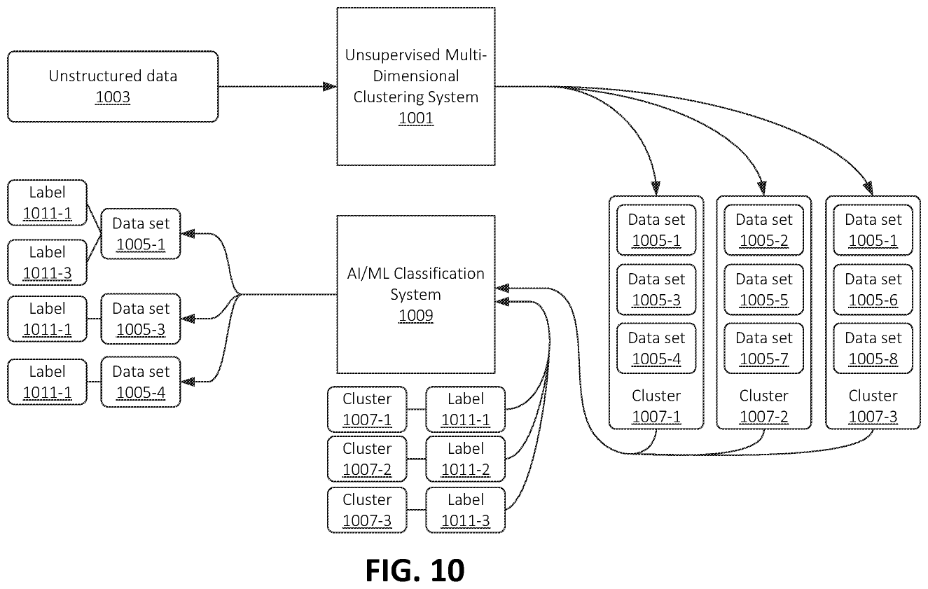

In some embodiments, some or all of the operations described above may be performed by Unsupervised Multi-Dimensional Clustering System 1001. For example, as shown in FIG. 10, Unsupervised Multi-Dimensional Clustering System 1001 may receive a set of unstructured data 1003. The unstructured data may include, as discussed above, KPIs of a wireless network, one or more content files (e.g., image, audio, text, video, etc.), time series data, and/or other suitable types of data. Unsupervised Multi-Dimensional Clustering System 1001 may, for example, receive wireless network KPIs from a Service Capability Exposure Function (“SCEF”) or Network Exposure Function (“NEF”) of a wireless network, a RAN controller, or other suitable type of device or system that reports or otherwise provides wireless network KPIs. In some embodiments, Unsupervised Multi-Dimensional Clustering System 1001 may receive image or video data from one or more autonomous vehicles or from a central repository that aggregates such data as collected by such autonomous vehicles. In some embodiments, unstructured data 1003 may be received from some other suitable source.

Unsupervised Multi-Dimensional Clustering System 1001 may perform some or all of operations 102-112 in order to generate distinct data sets 1005 (e.g., example data sets 1005-1 through 1005-8) and associate such data sets 1005 with respective clusters 1007. For example, as discussed above, Unsupervised Multi-Dimensional Clustering System 1001 may generate respective Eigenvectors to represent the maximum variation for each data set 1005, and may generate multi-dimensional projected vectors based on the values of each data set 1005 and the respective Eigenvector for each data set 1005. Clusters 1007 may be determined by performing a similarity analysis and/or clustering technique on each data set 1005, to identify data sets 1005 with matching or similar (e.g., within a threshold measure of similarity) multi-dimensional projected vectors.

In some embodiments, clusters 1007 may further be used to generate or refine one or more AI/ML models or other suitable models (e.g., which may be used to identify particular labels, categories, classifications, etc. for a respective set of input data). As shown in FIG. 10, AI/ML Classification System 1009 may receive or identify clusters 1007 (e.g., which indicate respective data sets 1005 that are associated with each cluster 1007). AI/ML Classification System 1009 may also receive one or more models, definitions, mappings, etc. that associate respective clusters 1007 with particular labels, categories, classifications, etc. (referred to herein simply as “labels 1011” for brevity). Such models, associations, etc. may have been generated or refined using AI/ML techniques (e.g., by AI/ML Classification System 1009 or some other suitable device or system) or using other suitable techniques. In some embodiments, the associations between clusters 1007 and respective labels 1011 may be determined using a supervised machine learning procedure, an unsupervised machine learning procedure, and/or other suitable procedure.

In the example where data sets 1005 include wireless network KPI information (e.g., interference information, signal quality information, traffic performance metrics, etc.), a particular label 1011 associated with a particular cluster 1007 may include a descriptor such as “high interference,” “good signal quality,” “overloaded,” etc. In an example where data sets 1005 include image or video data used for autonomous vehicle control applications, a particular label 1011 associated with a particular cluster 1007 may include a descriptor of prominent features depicted in the image or video data, such as “school bus,” “crosswalk,” “bridge,” etc.

AI/ML Classification System 1009 may further refine one or more models associating particular data sets 1005 with particular labels 1011. For example, based on the association of data set 1005-1 with clusters 1007-1 and 1007-3, and further based on the respective associations between clusters 1007-1 and 1007-2 with labels 1011-1 and 1011-3, AI/ML Classification System 1009 may generate or modify such models to associate data set 1005-1 with labels 1011-1 and 1011-3. AI/ML Classification System 1009 may similarly associate data sets 1005-3 and 1005-4 with label 1011-1, and so on. The models may be used to classify, categorize, etc. input data in order to identify particular labels 1011 associated with such input data. For example, a wireless network operator may utilize the models, that have been generated based on clustering performed by Unsupervised Multi-Dimensional Clustering System 1001, to identify particular network conditions (e.g., network overload conditions, poor radio quality conditions, etc.) and perform automated remedial measures (e.g., e.g., actions such as modifying radio resource allocations, modifying beamforming parameters of the wireless network, etc.) in response to such network conditions.

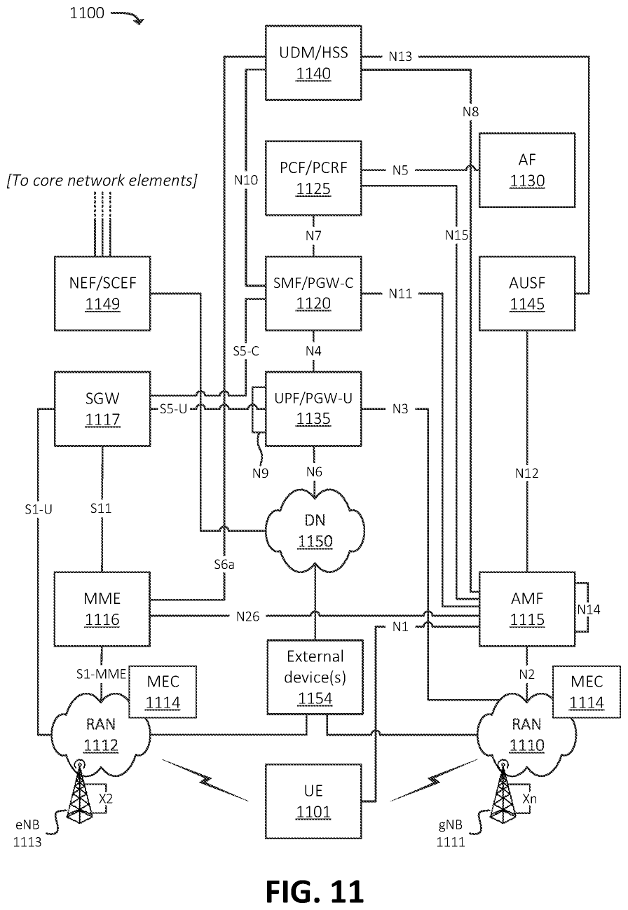

FIG. 11 illustrates an example environment 1100, in which one or more embodiments may be implemented. In some embodiments, environment 1100 may correspond to a Fifth Generation (“5G”) network, and/or may include elements of a 5G network. In some embodiments, environment 1100 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1100 may represent or may include a 5G core (“5GC”). As shown, environment 1100 may include UE 1101, RAN 1110 (which may include one or more Next Generation Node Bs (“gNBs”) 1111), RAN 1112 (which may include one or more evolved Node Bs (“eNBs”) 1113), and various network functions such as Access and Mobility Management Function (“AMF”) 1115, Mobility Management Entity (“MME”) 1116, Serving Gateway (“SGW”) 1117, Session Management Function (“SMF”)/Packet Data Network (“PDN”) Gateway (“PGW”)—Control plane function (“PGW-C”) 1120, Policy Control Function (“PCF”)/Policy Charging and Rules Function (“PCRF”) 1125, Application Function (“AF”) 1130, User Plane Function (“UPF”)/PGW-User plane function (“PGW-U”) 1135, Unified Data Management (“UDM”)/Home Subscriber Server (“HSS”) 1140, Authentication Server Function (“AUSF”) 1145, and Network Exposure Function NEF/SCEF 1149. Environment 1100 may also include one or more networks, such as Data Network (“DN”) 1150. Environment 1100 may include one or more additional devices or systems communicatively coupled to one or more networks (e.g., DN 1150), such as one or more external devices 1154.

The example shown in FIG. 11 illustrates one instance of each network component or function (e.g., one instance of SMF/PGW-C 1120, PCF/PCRF 1125, UPF/PGW-U 1135, UDM/HSS 1140, and/or AUSF 1145). In practice, environment 1100 may include multiple instances of such components or functions. For example, in some embodiments, environment 1100 may include multiple “slices” of a core network, where each slice includes a discrete and/or logical set of network functions (e.g., one slice may include a first instance of AMF 1115, SMF/PGW-C 1120, PCF/PCRF 1125, and/or UPF/PGW-U 1135, while another slice may include a second instance of AMF 1115, SMF/PGW-C 1120, PCF/PCRF 1125, and/or UPF/PGW-U 1135). The different slices may provide differentiated levels of service, such as service in accordance with different Quality of Service (“QoS”) parameters.

The quantity of devices and/or networks, illustrated in FIG. 11, is provided for explanatory purposes only. In practice, environment 1100 may include additional devices and/or networks, fewer devices and/or networks, different devices and/or networks, or differently arranged devices and/or networks than illustrated in FIG. 11. For example, while not shown, environment 1100 may include devices that facilitate or enable communication between various components shown in environment 1100, such as routers, modems, gateways, switches, hubs, etc. In some implementations, one or more devices of environment 1100 may be physically integrated in, and/or may be physically attached to, one or more other devices of environment 1100. Alternatively, or additionally, one or more of the devices of environment 1100 may perform one or more network functions described as being performed by another one or more of the devices of environment 1100.

Additionally, one or more elements of environment 1100 may be implemented in a virtualized and/or containerized manner. For example, one or more of the elements of environment 1100 may be implemented by one or more Virtualized Network Functions (“VNFs”), Cloud-Native Network Functions (“CNFs”), etc. In such embodiments, environment 1100 may include, may implement, and/or may be communicatively coupled to an orchestration platform that provisions hardware resources, installs containers or applications, performs load balancing, and/or otherwise manages the deployment of such elements of environment 1100. In some embodiments, such orchestration and/or management of such elements of environment 1100 may be performed by, or in conjunction with, the open-source Kubernetes® application programming interface (“API”) or some other suitable virtualization, containerization, and/or orchestration system.

Elements of environment 1100 may interconnect with each other and/or other devices via wired connections, wireless connections, or a combination of wired and wireless connections. Examples of interfaces or communication pathways between the elements of environment 1100, as shown in FIG. 11, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 11, such as Service-Based Interfaces (“SBIs”), including an Namf interface, an Nudm interface, an Npcf interface, an Nupf interface, an Nnef interface, an Nsmf interface, and/or one or more other SBIs.

UE 1101 may include a computation and communication device, such as a wireless mobile communication device that is capable of communicating with RAN 1110, RAN 1112, and/or DN 1150. UE 1101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), a Fixed Wireless Access (“FWA”) device, or another type of mobile computation and communication device. UE 1101 may send traffic to and/or receive traffic (e.g., user plane traffic) from DN 1150 via RAN 1110, RAN 1112, and/or UPF/PGW-U 1135.

RAN 1110 may be, or may include, a 5G RAN that implements a 5G RAT and that includes one or more base stations (e.g., one or more gNBs 1111), via which UE 1101 may communicate with one or more other elements of environment 1100. UE 1101 may communicate with RAN 1110 via an air interface (e.g., as provided by gNB 1111). For instance, RAN 1110 may receive traffic (e.g., user plane traffic such as voice call traffic, data traffic, messaging traffic, etc.) from UE 1101 via the air interface, and may communicate the traffic to UPF/PGW-U 1135 and/or one or more other devices or networks. Further, RAN 1110 may receive signaling traffic, control plane traffic, etc. from UE 1101 via the air interface, and may communicate such signaling traffic, control plane traffic, etc. to AMF 1115 and/or one or more other devices or networks. Additionally, RAN 1110 may receive traffic intended for UE 1101 (e.g., from UPF/PGW-U 1135, AMF 1115, and/or one or more other devices or networks) and may communicate the traffic to UE 1101 via the air interface.

RAN 1112 may be, or may include, an LTE RAN that implements an LTE RAT and that includes one or more base stations (e.g., one or more eNBs 1113), via which UE 1101 may communicate with one or more other elements of environment 1100. UE 1101 may communicate with RAN 1112 via an air interface (e.g., as provided by eNB 1113). For instance, RAN 1112 may receive traffic (e.g., user plane traffic such as voice call traffic, data traffic, messaging traffic, signaling traffic, etc.) from UE 1101 via the air interface, and may communicate the traffic to UPF/PGW-U 1135 (e.g., via SGW 1117) and/or one or more other devices or networks. Further, RAN 1112 may receive signaling traffic, control plane traffic, etc. from UE 1101 via the air interface, and may communicate such signaling traffic, control plane traffic, etc. to MME 1116 and/or one or more other devices or networks. Additionally, RAN 1112 may receive traffic intended for UE 1101 (e.g., from UPF/PGW-U 1135, MME 1116, SGW 1117, and/or one or more other devices or networks) and may communicate the traffic to UE 1101 via the air interface.

One or more RANs of environment 1100 (e.g., RAN 1110 and/or RAN 1112) may include, may implement, and/or may otherwise be communicatively coupled to one or more edge computing devices, such as one or more Multi-Access/Mobile Edge Computing (“MEC”) devices (referred to sometimes herein simply as a “MECs”) 1114. MECs 1114 may be co-located with wireless network infrastructure equipment of RANs 1110 and/or 1112 (e.g., one or more gNBs 1111 and/or one or more eNBs 1113, respectively). Additionally, or alternatively, MECs 1114 may otherwise be associated with geographical regions (e.g., coverage areas) of wireless network infrastructure equipment of RANs 1110 and/or 1112. In some embodiments, one or more MECs 1114 may be implemented by the same set of hardware resources, the same set of devices, etc. that implement wireless network infrastructure equipment of RANs 1110 and/or 1112. In some embodiments, one or more MECs 1114 may be implemented by different hardware resources, a different set of devices, etc. from hardware resources or devices that implement wireless network infrastructure equipment of RANs 1110 and/or 1112. In some embodiments, MECs 1114 may be communicatively coupled to wireless network infrastructure equipment of RANs 1110 and/or 1112 (e.g., via a high-speed and/or low-latency link such as a physical wired interface, a high-speed and/or low-latency wireless interface, or some other suitable communication pathway).

MECs 1114 may include hardware resources (e.g., configurable or provisionable hardware resources) that may be configured to provide services and/or otherwise process traffic to and/or from UE 1101, via RAN 1110 and/or 1112. For example, RAN 1110 and/or 1112 may route some traffic from UE 1101 (e.g., traffic associated with one or more particular services, applications, application types, etc.) to a respective MEC 1114 instead of to core network elements of 1100 (e.g., UPF/PGW-U 1135). MEC 1114 may accordingly provide services to UE 1101 by processing such traffic, performing one or more computations based on the received traffic, and providing traffic to UE 1101 via RAN 1110 and/or 1112. MEC 1114 may include, and/or may implement, some or all of the functionality described above with respect to UPF/PGW-U 1135, AF 1130, one or more application servers, and/or one or more other devices, systems, VNFs, CNFs, etc. In this manner, ultra-low latency services may be provided to UE 1101, as traffic does not need to traverse links (e.g., backhaul links) between RAN 1110 and/or 1112 and the core network.

AMF 1115 may include one or more devices, systems, VNFs, CNFs, etc., that perform operations to register UE 1101 with the 5G network, to establish bearer channels associated with a session with UE 1101, to hand off UE 1101 from the 5G network to another network, to hand off UE 1101 from the other network to the 5G network, manage mobility of UE 1101 between RANs 1110 and/or gNBs 1111, and/or to perform other operations. In some embodiments, the 5G network may include multiple AMFs 1115, which communicate with each other via the N14 interface (denoted in FIG. 11 by the line marked “N14” originating and terminating at AMF 1115).

MME 1116 may include one or more devices, systems, VNFs, CNFs, etc., that perform operations to register UE 1101 with the EPC, to establish bearer channels associated with a session with UE 1101, to hand off UE 1101 from the EPC to another network, to hand off UE 1101 from another network to the EPC, manage mobility of UE 1101 between RANs 1112 and/or eNBs 1113, and/or to perform other operations.

SGW 1117 may include one or more devices, systems, VNFs, CNFs, etc., that aggregate traffic received from one or more eNBs 1113 and send the aggregated traffic to an external network or device via UPF/PGW-U 1135. Additionally, SGW 1117 may aggregate traffic received from one or more UPF/PGW-Us 1135 and may send the aggregated traffic to one or more eNBs 1113. SGW 1117 may operate as an anchor for the user plane during inter-eNB handovers and as an anchor for mobility between different telecommunication networks or RANs (e.g., RANs 1110 and 1112).

SMF/PGW-C 1120 may include one or more devices, systems, VNFs, CNFs, etc., that gather, process, store, and/or provide information in a manner described herein. SMF/PGW-C 1120 may, for example, facilitate the establishment of communication sessions on behalf of UE 1101. In some embodiments, the establishment of communications sessions may be performed in accordance with one or more policies provided by PCF/PCRF 1125.

PCF/PCRF 1125 may include one or more devices, systems, VNFs, CNFs, etc., that aggregate information to and from the 5G network and/or other sources. PCF/PCRF 1125 may receive information regarding policies and/or subscriptions from one or more sources, such as subscriber databases and/or from one or more users (such as, for example, an administrator associated with PCF/PCRF 1125).

AF 1130 may include one or more devices, systems, VNFs, CNFs, etc., that receive, store, and/or provide information that may be used in determining parameters (e.g., quality of service parameters, charging parameters, or the like) for certain applications.

UPF/PGW-U 1135 may include one or more devices, systems, VNFs, CNFs, etc., that receive, store, and/or provide data (e.g., user plane data). For example, UPF/PGW-U 1135 may receive user plane data (e.g., voice call traffic, data traffic, etc.), destined for UE 1101, from DN 1150, and may forward the user plane data toward UE 1101 (e.g., via RAN 1110, SMF/PGW-C 1120, and/or one or more other devices). In some embodiments, multiple instances of UPF/PGW-U 1135 may be deployed (e.g., in different geographical locations), and the delivery of content to UE 1101 may be coordinated via the N9 interface (e.g., as denoted in FIG. 11 by the line marked “N9” originating and terminating at UPF/PGW-U 1135). Similarly, UPF/PGW-U 1135 may receive traffic from UE 1101 (e.g., via RAN 1110, RAN 1112, SMF/PGW-C 1120, and/or one or more other devices), and may forward the traffic toward DN 1150. In some embodiments, UPF/PGW-U 1135 may communicate (e.g., via the N4 interface) with SMF/PGW-C 1120, regarding user plane data processed by UPF/PGW-U 1135.

UDM/HSS 1140 and AUSF 1145 may include one or more devices, systems, VNFs, CNFs, etc., that manage, update, and/or store, in one or more memory devices associated with AUSF 1145 and/or UDM/HSS 1140, profile information associated with a subscriber. In some embodiments, UDM/HSS 1140 may include, may implement, may be communicatively coupled to, and/or may otherwise be associated with some other type of repository or database, such as a Unified Data Repository (“UDR”). AUSF 1145 and/or UDM/HSS 1140 may perform authentication, authorization, and/or accounting operations associated with one or more UEs 1101 and/or one or more communication sessions associated with one or more UEs 1101.

DN 1150 may include one or more wired and/or wireless networks. For example, DN 1150 may include an Internet Protocol (“IP”)-based PDN, a wide area network (“WAN”) such as the Internet, a private enterprise network, and/or one or more other networks. UE 1101 may communicate, through DN 1150, with data servers, other UEs 1101, and/or to other servers or applications that are coupled to DN 1150. DN 1150 may be connected to one or more other networks, such as a public switched telephone network (“PSTN”), a public land mobile network (“PLMN”), and/or another network. DN 1150 may be connected to one or more devices, such as content providers, applications, web servers, and/or other devices, with which UE 1101 may communicate.

External devices 1154 may include one or more devices or systems that communicate with UE 1101 via DN 1150 and one or more elements of 1100 (e.g., via UPF/PGW-U 1135). In some embodiments, external devices 1154 may include, may implement, and/or may otherwise be associated with Unsupervised Multi-Dimensional Clustering System 1001 and/or AI/ML Classification System 1009. External devices 1154 may include, for example, one or more application servers, content provider systems, web servers, or the like. External devices 1154 may, for example, implement “server-side” applications that communicate with “client-side” applications executed by UE 1101. External devices 1154 may provide services to UE 1101 such as gaming services, videoconferencing services, messaging services, email services, web services, and/or other types of services.

In some embodiments, external devices 1154 may communicate with one or more elements of environment 1100 (e.g., core network elements) via NEF/SCEF 1149. NEF/SCEF 1149 include one or more devices, systems, VNFs, CNFs, etc. that provide access to information, APIs, and/or other operations or mechanisms of one or more core network elements to devices or systems that are external to the core network (e.g., to external device 1154 via DN 1150). NEF/SCEF 1149 may maintain authorization and/or authentication information associated with such external devices or systems, such that NEF/SCEF 1149 is able to provide information, that is authorized to be provided, to the external devices or systems. For example, a given external device 1154 may request particular information associated with one or more core network elements. NEF/SCEF 1149 may authenticate the request and/or otherwise verify that external device 1154 is authorized to receive the information, and may request, obtain, or otherwise receive the information from the one or more core network elements. In some embodiments, NEF/SCEF 1149 may include, may implement, may be implemented by, may be communicatively coupled to, and/or may otherwise be associated with a Security Edge Protection Proxy (“SEPP”), which may perform some or all of the functions discussed above. External device 1154 may, in some situations, subscribe to particular types of requested information provided by the one or more core network elements, and the one or more core network elements may provide (e.g., “push”) the requested information to NEF/SCEF 1149 (e.g., in a periodic or otherwise ongoing basis).

In some embodiments, external devices 1154 may communicate with one or more elements of RAN 1110 and/or 1112 via an API or other suitable interface. For example, a given external device 1154 may provide instructions, requests, etc. to RAN 1110 and/or 1112 to provide one or more services via one or more respective MECs 1114. In some embodiments, such instructions, requests, etc. may include QoS parameters, Service Level Agreements (“SLAs”), etc. (e.g., maximum latency thresholds, minimum throughput thresholds, etc.) associated with the services.

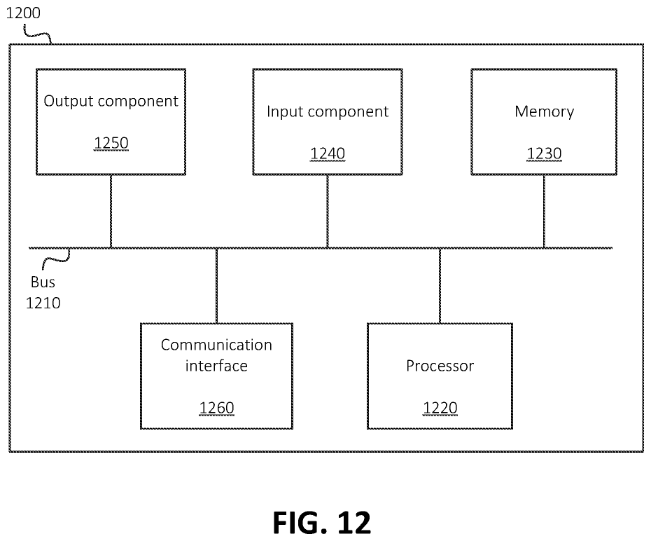

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, a set of provisioned hardware resources of a cloud computing system, or other suitable type of hardware that interprets and/or executes instructions (e.g., processor-executable instructions). In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to input component 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems (e.g., via RAN 1110, RAN 1112, DN 1150, etc.). For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1200 may include more than one communication interface 1260. For instance, device 1200 may include an optical interface, a wireless interface, an Ethernet interface, and/or one or more other interfaces.

Device 1200 may perform certain operations relating to one or more processes described above. Device 1200 may perform these operations in response to processor 1220 executing instructions, such as software instructions, processor-executable instructions, etc. stored in a computer-readable medium, such as memory 1230. A computer-readable medium may be defined as a non-transitory memory device. A memory device may include space within a single physical memory device or spread across multiple physical memory devices. The instructions may be read into memory 1230 from another computer-readable medium or from another device. The instructions stored in memory 1230 may be processor-executable instructions that cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above- mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information. No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a plurality of multi-dimensional data sets;
generate, for each multi-dimensional data set, an Eigenvector, wherein a particular Eigenvector for a particular multi-dimensional data set represents a maximum variance of the particular multi-dimensional data set;
generate, for each multi-dimensional data set, a projected vector, wherein generating a particular projected vector includes identifying a lowest distance between respective multi-dimensional values of the particular data set and the particular Eigenvector, wherein the particular projected vector includes multi-dimensional values along the Eigenvector that are each a lowest distance from a corresponding multi-dimensional value of the particular data set;
compare respective projected vectors, associated with one or more multi-dimensional data sets, with one or more other multi-dimensional data sets of the plurality of multi-dimensional data sets;
generate a plurality of clusters based on the comparing, wherein each cluster includes one or more multi-dimensional data sets of the plurality of multi-dimensional data sets; and
train one or more artificial intelligence/machine learning (“AI/ML”) models based on the plurality of clusters.

2. The device of claim 1, wherein the plurality of multi-dimensional data sets include wireless network Key Performance Indicators (“KPIs”), wherein training the one or more AI/ML models includes identifying one or more network conditions associated with respective clusters.

3. The device of claim 2, wherein the one or more processors are further configured to:
receive KPIs of a particular wireless network;
determine, based on the one or more AI/ML models, that the received KPIs are associated with a particular cluster that is further associated with a particular network condition;
identify one or more remedial actions associated with the particular network condition; and
modify configuration parameters of the wireless network based on the identified one or more remedial actions.

4. The device of claim 1, wherein the particular multi-dimensional data set includes a particular quantity of instances of a plurality of parameters, wherein a dimensionality of the particular multi-dimensional data set is based on the particular quantity of instances.

5. The device of claim 4, wherein a dimensionality of the Eigenvector is based on the particular quantity of instances.

6. The device of claim 1, wherein the particular projected vector represents a signature of the particular data set.

7. The device of claim 1, wherein a particular cluster includes a first multi-dimensional data set and a second multi-dimensional data set of the plurality of multi-dimensional data sets, wherein generating the particular cluster includes:
determining a measure of similarity between a first projected vector, associated with the first multi-dimensional data set, and a second first projected vector associated with the second multi-dimensional data set; and
determining that the measure of similarity exceeds a threshold measure of similarity.

8. A non-transitory computer-readable medium, storing a plurality of processor-executable instructions to:
receive a plurality of multi-dimensional data sets;
generate, for each multi-dimensional data set, an Eigenvector, wherein a particular Eigenvector for a particular multi-dimensional data set represents a maximum variance of the particular multi-dimensional data set;
generate, for each multi-dimensional data set, a projected vector, wherein generating a particular projected vector includes identifying a lowest distance between respective multi-dimensional values of the particular data set and the particular Eigenvector, wherein the particular projected vector includes multi-dimensional values along the Eigenvector that are each a lowest distance from a corresponding multi-dimensional value of the particular data set;
compare respective projected vectors, associated with one or more multi-dimensional data sets, with one or more other multi-dimensional data sets of the plurality of multi-dimensional data sets;
generate a plurality of clusters based on the comparing, wherein each cluster includes one or more multi-dimensional data sets of the plurality of multi-dimensional data sets; and
train one or more artificial intelligence/machine learning (“AI/ML”) models based on the plurality of clusters.

9. The non-transitory computer-readable medium of claim 8, wherein the plurality of multi-dimensional data sets include wireless network Key Performance Indicators (“KPIs”), wherein training the one or more AI/ML models includes identifying one or more network conditions associated with respective clusters.

10. The non-transitory computer-readable medium of claim 9, wherein the plurality of processor-executable instructions further include processor-executable instructions to:
receive KPIs of a particular wireless network;
determine, based on the one or more AI/ML models, that the received KPIs are associated with a particular cluster that is further associated with a particular network condition;
identify one or more remedial actions associated with the particular network condition; and
modify configuration parameters of the wireless network based on the identified one or more remedial actions.

11. The non-transitory computer-readable medium of claim 8, wherein the particular multi-dimensional data set includes a particular quantity of instances of a plurality of parameters, wherein a dimensionality of the particular multi-dimensional data set is based on the particular quantity of instances.

12. The non-transitory computer-readable medium of claim 11, wherein a dimensionality of the Eigenvector is based on the particular quantity of instances.

13. The non-transitory computer-readable medium of claim 8, wherein the particular projected vector represents a signature of the particular data set.

14. The non-transitory computer-readable medium of claim 8, wherein a particular cluster includes a first multi-dimensional data set and a second multi-dimensional data set of the plurality of multi-dimensional data sets, wherein generating the particular cluster includes:
determining a measure of similarity between a first projected vector, associated with the first multi-dimensional data set, and a second first projected vector associated with the second multi-dimensional data set; and
determining that the measure of similarity exceeds a threshold measure of similarity.

15. A method, comprising:
receiving a plurality of multi-dimensional data sets;
generating, for each multi-dimensional data set, an Eigenvector, wherein a particular Eigenvector for a particular multi-dimensional data set represents a maximum variance of the particular multi-dimensional data set;
generating, for each multi-dimensional data set, a projected vector, wherein generating a particular projected vector includes identifying a lowest distance between respective multi-dimensional values of the particular data set and the particular Eigenvector, wherein the particular projected vector includes multi-dimensional values along the Eigenvector that are each a lowest distance from a corresponding multi-dimensional value of the particular data set;
comparing respective projected vectors, associated with one or more multi-dimensional data sets, with one or more other multi-dimensional data sets of the plurality of multi-dimensional data sets;
generating a plurality of clusters based on the comparing, wherein each cluster includes one or more multi-dimensional data sets of the plurality of multi-dimensional data sets; and
training one or more artificial intelligence/machine learning (“AI/ML”) models based on the plurality of clusters.

16. The method of claim 15, wherein the plurality of multi-dimensional data sets include wireless network Key Performance Indicators (“KPIs”), wherein training the one or more AI/ML models includes identifying one or more network conditions associated with respective clusters, wherein the method comprises:
receiving KPIs of a particular wireless network;
determining, based on the one or more AI/ML models, that the received KPIs are associated with a particular cluster that is further associated with a particular network condition;
identifying one or more remedial actions associated with the particular network condition; and
modifying configuration parameters of the wireless network based on the identified one or more remedial actions.

17. The method of claim 15, wherein the particular multi-dimensional data set includes a particular quantity of instances of a plurality of parameters, wherein a dimensionality of the particular multi-dimensional data set is based on the particular quantity of instances.

18. The method of claim 17, wherein a dimensionality of the Eigenvector is based on the particular quantity of instances.

19. The method of claim 15, wherein the particular projected vector represents a signature of the particular data set.

20. The method of claim 15, wherein a particular cluster includes a first multi-dimensional data set and a second multi-dimensional data set of the plurality of multi-dimensional data sets, wherein generating the particular cluster includes:
determining a measure of similarity between a first projected vector, associated with the first multi-dimensional data set. and a second first projected vector associated with the second multi-dimensional data set; and
determining that the measure of similarity exceeds a threshold measure of similarity.
